(19) United States
(12) Patent Application Publication
(10) Pub. No.: US 2026/0249869 A1
(43) Pub. Date: Aug. 27, 2026

(54) DRIVER MONITORING SYSTEM ACTION RECOGNITION

(71) Applicant: Rivian IP Holdings, LLC, Irvine, CA (US)

(72) Inventors: Dushyant Goyal, South San Francisco, CA (US); Yan Zhai, Milpitas, CA (US); James William Vaisey Philbin, Palo Alto, CA (US); Nick David Carlevaris-Bianco, Santa Clara, CA (US); Vinay Palakkode, Santa Clara, CA (US); Nikan Salarieh, Palo Alto, CA (US)

(21) Appl. No.: 19/063,030

(22) Filed: Feb. 25, 2025

(51) Int. Cl. B60W 50/14; B60W 40/08; G06V 10/75; G06V 10/77; G06V 20/59; G06V 40/18

(52) U.S. Cl. CPC B60W 50/14; B60W 40/08; G06V 10/751; G06V 10/7715; G06V 20/597; G06V 40/18; B60W 2040/0818; B60W 2050/143; B60W 2050/146; B60W 2420/403; B60W 2540/225; B60W 2540/229

(57) ABSTRACT

Techniques for monitoring activity of a driver in a vehicle include identifying one or more objects in each frame of a plurality of image frames, identifying one or more features for each frame based on the one or more objects, determining a short action for each frame based on the one or more features and based on reference information linking a plurality of reference features and a plurality of reference short actions to generate a time sequence of short actions, applying a filter to the time sequence of short actions to generated a sequence of filtered short actions, and transmitting a signal to an output interface to generate an indication to the driver based on the sequence of filtered short actions. Techniques may also include determining at least one long action based on a plurality of features, and causing the indication based on the at least one long action.

### INTRODUCTION

The present disclosure is directed to a driver monitoring system (DMS) that recognizes driver actions to determine whether the driver is distracted.

### SUMMARY

In some embodiments, the present disclosure is directed to a method for monitoring activity of a driver in a vehicle based on image frames is captured by a camera directed at an occupant compartment of the vehicle. In some embodiments, the method includes identifying one or more objects in each frame of a plurality of image frames, identifying one or more features for each frame based on the one or more objects, determining a short action for each frame based on the one or more features and based on reference information linking a plurality of reference features and a plurality of reference short actions to generate a time sequence of short actions, applying a filter to the time sequence of short actions to generated a sequence of filtered short actions, and transmitting a signal to an output interface to generate an indication to the driver based on the sequence of filtered short actions.

In some embodiments, the method includes determining the short action by performing at least one of determining the driver is looking to a side, determining the driver is looking upward, determining the driver is looking downward, determining the driver is looking at a road, determining the driver's eyes are closed, determining the driver's body pose does not match a reference (e.g., normal) driving body pose. For example, short actions may include a driver bending their body forward, their body reaching to the passenger side, their body reaching towards a second row (e.g., a rear seat), or a driver's gaze being blocked by other objects (e.g., such as sun visor or other object). In some embodiments, identifying the one or more objects includes performing at least one of, for each frame, identifying pixels corresponding to a body of the driver, identifying pixels corresponding to a face of the driver, and identifying pixels corresponding to at least one eye of the driver.

In some embodiments, applying the filter includes applying a window to a respective subset of short actions of the time sequence of short actions, and determining the respective filtered short action based on the respective subset of short actions. In some embodiments, the method includes generating a feature vector that includes the identified one or more features for each frame of the plurality of image frames, and determining the short action for each frame is based in part on the feature vector.

In some embodiments, the reference information is first reference information, and the method includes determining at least one long action based on the feature vector and based on second reference information linking a plurality of reference sequences of features to a plurality of reference long actions. In some embodiments, the method includes determining at least one long action based on the feature vector, and transmitting the signal to the output interface to generate the indication is further based on the at least one long action. In some embodiments, determining the at least one long action includes performing at least one of determining the driver is text messaging, determining the driver is interacting with an infotainment system, determining the driver is eating, determining the driver is sleeping, determining whether the driver is performing other actions that may cause distraction or otherwise affect attention, or any combination thereof. In some embodiments, determining the short action for each frame is independent of geometric mapping of the occupant compartment, and determining the at least one long action is independent of geometric mapping of the occupant compartment.

In some embodiments, the present disclosure is directed to a method for monitoring activity of a driver in a vehicle based on recognizing short actions and long actions. In some embodiments, the method includes extracting one or more features from each frame of a sequence of image frames to generate a feature vector, determining a sequence of short actions based on the feature vector and based on first reference information linking a first plurality of reference features and a plurality of reference short actions, determining at least one long action based on the feature vector and based on second reference information linking a second plurality of reference features and a plurality of reference long actions, and transmitting a signal to an output interface to generate an indication to the driver based on the sequence of short actions and based on the at least one long action. In some embodiments, transmitting the signal to the output interface is further based on at least one operating parameter of the vehicle. For example, the at least one operating parameter may include an unlocked/locked state, occupancy state, vehicle speed, vehicle on/off status, braking action, steering action, dash interactions, any other suitable information, or any combination thereof. In some embodiments, the method includes applying a time filter to the sequence of short actions to generate a sequence of filtered short actions. For example, in some such embodiments, determining the sequence of short actions occurs at a first rate, the time filter comprises a window spanning more than one frame, and the sequence of filtered short actions corresponds to a second rate less than or equal to the first rate.

In some embodiments, determining the at least one long action is based on a sequence of features of the feature vector. In some embodiments, determining the at least one long action is further based on the sequence of short actions, and the at least one long action corresponds to a plurality of image frames spanning more than one second.

In some embodiments, the present disclosure is directed to a driver monitoring system that analyzes a plurality of image frames captured by a camera directed at an occupant compartment of a vehicle. In some embodiments, the system includes control circuitry configured to identify one or more objects in each frame of a plurality of image frames, identify one or more features for each frame based on the one or more objects, determine a short action for each frame based on the one or more features and based on reference information linking a plurality of reference features and a plurality of reference short actions to generate a time sequence of short actions, apply a filter to the time sequence of short actions to generated a sequence of filtered short actions, and cause an indication to a driver to be generated based on the sequence of filtered short actions. In some embodiments, the system includes an output interface configured to generate the indication, and the control circuitry is configured to transmit a signal to the output interface.

In some embodiments, identifying the one or more features includes extracting one or more features from each frame of the plurality of image frames to generate a feature vector. In some embodiments, the control circuitry is further configured to determine at least one long action based on the feature vector, and cause the indication to be generated is based on the at least one long action. In some embodiments, the control circuitry is configured to determine the at least one long action further based on the time sequence of short actions, and the at least one long action corresponds to a set of image frames spanning more than one second. In some embodiments, the control circuitry is configured to determine the short action for each frame independent of geometric mapping of the occupant compartment, and determine the at least one long action independent of geometric mapping of the occupant compartment.

### BRIEF DESCRIPTION OF THE DRAWINGS

The present disclosure, in accordance with one or more various embodiments, is described in detail with reference to the following figures. The drawings are provided for purposes of illustration only and merely depict illustrative embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 is a block diagram of an illustrative vehicle having a driver monitoring system, in accordance with some embodiments of the present disclosure;

FIG. 2 shows an illustrative interface of a vehicle for providing indications to a driver, in accordance with some embodiments of the present disclosure;

FIG. 3 shows a system diagram of an illustrative system for monitoring driver actions, in accordance with some embodiments of the present disclosure;

FIG. 4 is a block diagram of an illustrative system for managing image data, in accordance with some embodiments of the present disclosure;

FIG. 5 is a flowchart of an illustrative process for determining short actions of a driver, in accordance with some embodiments of the present disclosure;

FIG. 6 is a flowchart of an illustrative process for determining short actions and long actions of a driver, in accordance with some embodiments of the present disclosure; and

FIG. 7 is a flowchart of an illustrative process for monitoring a driver of a vehicle, in accordance with some embodiments of the present disclosure.

### DETAILED DESCRIPTION

In some embodiments, the present disclosure is directed to a system that determines short actions of a driver, and optionally long actions, based on image frames, without the need for geometry vectors mapping of the occupant compartment. Short actions may include short glance changes such as the driver looking left, right, up, down, on-road, or closing their eyes, for example, which may last a few seconds or less. Long actions may include longer time-scale actions such as eating, texting, interacting with an infotainment system, or other actions that may take more than ten seconds or even minutes. To illustrate, by using a data-driven, deep learning approach, the technique of the present disclosure is scalable and does not require geometric computation of the driver's gaze and the layout of the vehicle interior.

In some embodiments, the system processes each image frame, identifies objects in each frame (e.g., driver body, face, and eyes), and then applies masking or cropping to the frames. Then, the system may identify one or more features in each frame. Based on these features, for example, the system applies a convoluted neural network backbone to classify short actions, determining a short action in connection with each frame. The system may temporally process the sequence of short actions (e.g., filter the short actions) to identify short actions at a different rate than the object detection and feature extraction occurs. A feature supervisor monitors the short actions and determines whether to alert the driver if the short actions indicate the driver is distracted. Additionally, or alternatively, the system may concatenate the features and provide them to a long action identifier. The long action identifier is sequence-based, rather than frame based or time based, and identifies long actions based on sequences of features. The feature supervisor may take as input the sequence of short actions, any identified long actions, operating parameters of the vehicle, or any combination thereof, to determine whether the driver is distracted and whether to alert the driver.

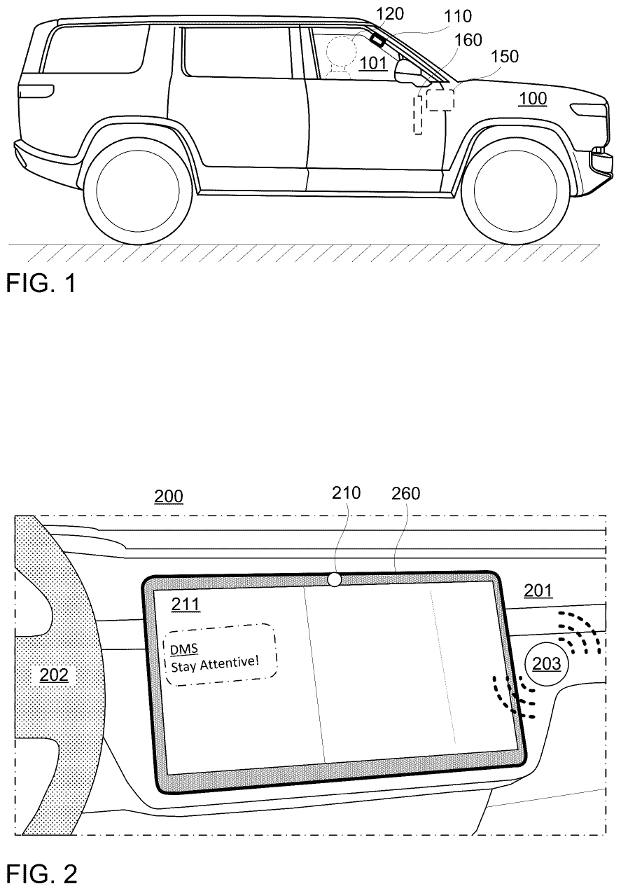

FIG. 1 is a block diagram of illustrative vehicle 100 having driver monitoring system (DMS) 150, in accordance with some embodiments of the present disclosure. As illustrated, vehicle 100 includes camera 110 (e.g., directed at an occupant compartment 101, where driver 120 may be located), use interface 160, and DMS 150. In some embodiments, DMS 150 may be configured to monitor activities of driver 120, determine whether driver 120 is distracted, and alert driver 120 if it is determined that driver 120 is distracted. For example, camera 110 may capture a series of image frames, and DMS 150 may process the image frames by identifying objects, applying masks, and identifying features, DMS 150 may then, based on the collection of features (e.g., concatenated as a feature vector), classify a short action for each frame and determine a temporally processed (e.g. filtered) sequence short actions. The distraction determination may be based on the sequence of short actions. Additionally, or alternatively, DMS 150 may be configured to determine one or more long actions of driver 120 based on a sequence of a plurality of features, and optionally also on the sequence of short actions. Accordingly, the distraction determination may be based on the long action, the short actions, or both. In some embodiments, DMS 150 takes as input vehicle parameters such as speed, parked status, locked or unlocked status, driver identification or preferences, infotainment settings, any other suitable information, or any combination thereof in determining whether driver 120 is distracted or not.

FIG. 2 shows an illustrative interface of a vehicle for providing indications to a driver, in accordance with some embodiments of the present disclosure. As illustrated, interface 211 is implemented on device 260 (e.g., having a touchscreen) arranged on dash 201 of vehicle 200 (e.g., a portion of steering wheel 202 is illustrated for reference). Interface 211 may include a display and an input interface (e.g., a touchscreen, hard buttons, or a combination thereof) of device 260. As illustrated, interface 211 is displaying an alert to the driver when distraction is detected. Interface 211 may be configured to store, process, and display any information and also to control or monitor alerts to the driver. In some embodiments, interface 211 may include an instrument cluster display, and need not include a touchscreen or otherwise accept input from a user. Additionally, device 203 (e.g., a speaker, as illustrated) may be configured to provide an auditory indication to the driver if the DMS determines that the driver is distracted. In some embodiments, camera 210 may be integrated as part of dash 201 (e.g., part of device 260 arranged in dash 201). Camera 210 may be configured to monitor a driver of the vehicle (e.g., may be directed to the driver's seat and be configured to capture image frames at any suitable frame rate). In an illustrative example, the DMS may generate an alert as a pop-up message (e.g., on a suitable display such as interface 211), a chime (e.g., using device 203), any other suitable signal or indication which may depend on the severity of the distraction, or any combination thereof. In a further example, the indication may include an alert that provides intuitive and ergonomic feedback to the driver (e.g., using chimes or haptic feedback), to engage the driver's attention. In some embodiments, the type of indication (e.g., alert) may depend on the severity of the distraction. For example, the longer a distraction is detected, the longer, louder, or more frequent, a chime may sound, or the larger or more shaded a visual display may be. In a further example, the indication may include a message (e.g., as text on a display, a voice or otherwise audible message using device 203, or a combination thereof) indicative of the severity of the distraction.

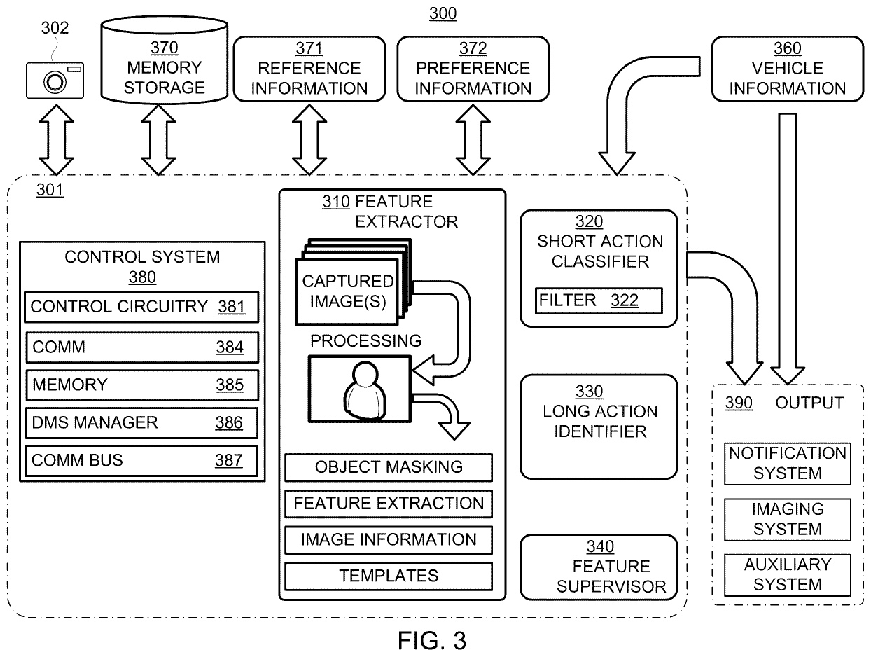

FIG. 3 shows a system diagram of illustrative system 300 for monitoring driver actions, in accordance with some embodiments of the present disclosure. As illustrated, system 300 includes camera 302, control system 380, reference information 371, preference information 372, memory storage 370, vehicle information 360, and output 390. It will be understood that the illustrated arrangement of system 300 may be modified in accordance with the present disclosure. For example, components may be combined, separated, increased in functionality, reduced in functionality, modified in functionality, omitted, or otherwise modified in accordance with the present disclosure. In some embodiments, system 301 may be referred to as a DMS system, and may take as input information from reference information 371, preference information 372, memory storage 370, and vehicle information 360 and cause output 390 to generate an indication to the driver. System 301 may be implemented as a combination of hardware and software, and may include, for example, control system 380 that includes control circuitry (e.g., for executing computer readable instructions), memory, a communications interface, a sensor interface, an input interface, a power supply (e.g., a power management system), any other suitable components, or any combination thereof. To illustrate, system 301 is configured to extract features from image frames or regions thereof, determine a short action classification (e.g., and smooth the classification), determine a long action, and generate or cause a suitable response to the classification or change in classification. As illustrated, feature extractor 310, short action classifier 320, long action identifier 330, and feature supervisor 340 may be implemented as software (e.g., computer instructions, executed by control system 380). It will be understood that any or all of feature extractor 310, short action classifier 320, long action identifier 330, and feature supervisor 340 may be implemented as hardware or a combination of hardware and software.

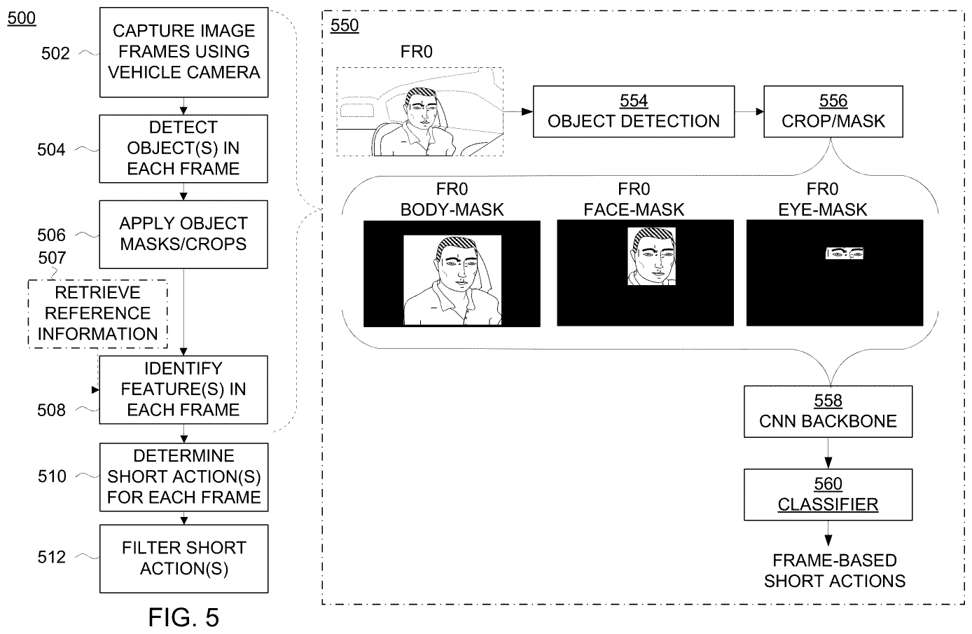

Control system 380, as illustrated, includes control circuitry 381 (e.g., as implemented by one or more electronic control units or ECUs), memory 385 (e.g., configured to store computer instructions), communications interface 384 (comm 324), communications bus 387, and optionally DMS manager 386. Control circuitry 381 may include a processor, an application specific integrated circuit (ASIC), a communications bus (e.g., in addition to or instead of communications bus 387), memory (e.g., in addition to or instead of memory 385), power management circuitry, a power supply, any suitable components, or any combination thereof. Memory 385 may include solid state memory, a hard disk, removable media, any other suitable memory hardware, or any combination thereof. In some embodiments, memory 385 is non-transitory computer readable media configured to store computer instructions that, when executed, perform at least some steps of any of process 500, process 600, or process 700 described in the context of FIGS. 5-7. In some embodiments, instructions are preprogrammed into memory 385, memory of one or more ECUs (e.g., which may include memory storage 370), or a combination thereof, for identifying objects, identifying features, determining short actions, determining long actions, managing features, or a combination thereof (e.g., as performed by DMS manager 386). In some embodiments, the instructions are loaded or otherwise provided to control circuitry 381 to perform diagnostics, manage an estimated range, or a combination thereof. To illustrate, DMS manager 386 may be implemented by control circuitry 381, operate separately but in communication with control circuitry 381 (e.g., via communications bus 387), or a combination thereof. In a further example, control system 380 may be configured implement the functions of feature extractor 310, short action classifier 320, long action identifier 330, feature supervisor 340, or a combination thereof.

Control system 380 may include an antenna and other control circuitry, or any combination thereof, and may be configured to access the internet, a local area network, a wide area network, a Bluetooth-enable device, an NFC-enabled device, any other suitable device using any suitable protocol, or any combination thereof. In some embodiments, control system 380 includes or otherwise is coupled to output 390, which may include, for example, a screen, a touchscreen, a touch pad, a keypad, one or more hard buttons, one or more soft buttons, a microphone, a speaker, any other suitable components, or any combination thereof. For example, in some embodiments, output 390 includes all or part of a dashboard, including displays, dials and gauges (e.g., actual or displayed), soft buttons, indicators, lighting, and other suitable features. In a further example, output 390 may include one or more hard buttons arranged at the exterior of the vehicle, interior of the vehicle (e.g., at the dash console), or at a dedicated keypad arranged at any suitable position. In a further example, output 390 may be configured to receive input from a user.

Comm 384 may include one or more ports, connectors, input/output (I/O) terminals, cables, wires, a printed circuit board, control circuitry, any other suitable components for communicating with other units, devices, or components, or any combination thereof. In some embodiments, control system 380 (e.g., ECUs thereof) is configured to control aspects of the vehicle. In some embodiments, comm 384, output 390, or both, may be configured to send and receive wireless information between control system 380 and external devices such as, for example, a remote system (e.g., a server, a WiFi access point), keyfobs, mobile devices, any other suitable devices, or any combination thereof. In some embodiments, communications bus 387 is integrated with comm 384 (e.g., communicatively coupling ECUs, charging interface 340, interface 360). In some embodiments, communications bus 387 may be coupled to comm 384.

In an illustrative example, vehicle 310 may include an on-board driver monitoring system that includes DMS manager 386. DMS manager 386 may be associated with control circuitry of a particular ECU of control circuitry 381, distributed among ECUs of control circuitry 381 (e.g., connected by communications bus 387), a separate controller, any other suitable control circuitry, or any combination thereof. In some embodiments, DMS manager 386 may be configured to generate a distraction estimate (e.g., a probability the driver is distracted), update the distraction estimate, determine or receive vehicle information 360, retrieve reference information 371, perform any other operation, or any combination thereof. In some embodiments, DMS manager 386, memory 385, or both, are configured to store information for determining whether a driver is distracted. In some embodiments, DMS manager 386 is configured to generate a display at output 390 to alert the driver, update an alert, or information corresponding to distractions or a distracted state. In an illustrative example, control system 380 or DMS manager 386 thereof may include an ADAS for controlling lane departure and driving mode.

Feature extractor 310 is configured to determine one or more features of image frames, as captured by camera 302. Feature extractor 310 may consider a single image (e.g., a set of one), a plurality of images, referencing information, or a combination thereof to determine a feature. For example, images may be captured at any suitable number of frames per second (fps), such as 5-10 fps, at a rate of 30 fps, or any other suitable frame rate. In a further example, feature extractor 310 may process a group of images (e.g., ten images, less than ten images, or more than ten images) for analysis in batches. In some embodiments, feature extractor 310 applies pre-processing to each image of the set of images to prepare the image for masking, cropping, and feature extraction. For example, feature extractor 310 may brighten the image or portions thereof, darken the image or portions thereof, color shift the image (e.g., among color schemes, from color to grayscale, or other mapping), crop the image, scale the image, adjusting an aspect ratio of the image, adjust contrast of an image, perform any other suitable processing to prepare image, or any combination thereof. In some embodiments, feature extractor 310 subsamples each image by dividing the image into regions according to a grid.

In some embodiments, feature extractor 310 identifies objects and then applies masking or cropping based on the identified objects. For example, feature extractor 310 may include software trained to detect objects corresponding to the driver such as the driver, the driver's face, and the driver's eyes. In a further example, feature extractor 310 may also be configured to detect objects such as a cell phone, water bottle, beverage containers, food, food containers, hats, glasses, sun-visor, headphones, earphones, books or documents, any other suitable object that may be in the occupant compartment, or any combination thereof (e.g., the driver's body, face, and eyes along with a mobile phone and a sun-visor). In some embodiments, feature extractor 310 may be trained using a convolutional neural network (CNN) to identify objects. In some embodiments, feature extractor 310 may be trained using predetermined features that are characteristic of each object. Once feature extractor 310 identifies the objects, feature extractor 310 may generate masks or otherwise crop the frame for each object. For example, when the driver is identified and the boundary of the driver is determined, a mask may be applied to render the pixels outside of the driver flat (e.g., all black, all white, unicolor, or otherwise without varying content). Similar masking may be applied to generate masked images of the driver's face and the driver's eyes. Based on these masked images, feature extractor 310 may then extract features. In some circumstances, where objects are not identified or not identified with a minimum confidence, feature extractor 310 may extract features of the full image without masking. Features may include for example, edges, ridges, points, corners, regions or shapes, textures, patterns, color, any other suitable feature, a gradient thereof, a maximum or minimum thereof, a statistical value thereof, or any combination thereof. For example, feature extractor 310 may identify spatial features of a single image or masked image such as, for example, scaled features, gradient features, min/max values, mean values, any other suitable feature indicative of spatial variation of an image (e.g., or region thereof), or any combination thereof. In a further example, feature extractor 310 may be configured to identify features such as image segmentation masks (e.g., partitioning an image into areas such as the driver, the back seat, the window by grouping pixels to generate the mask) or features derived thereof, an encoded or otherwise compressed version of image pixels within a region of interest (ROI) which may be based on a segmentation mask, any other suitable feature, or any combination thereof. In some embodiments, feature extractor 310 may receive as input signals from more than one source. For example, feature extractor 310 may receive image frames from a cabin monitoring camera, a steering wheel angle, microphone input, turn signal state, any other suitable data, to extract any suitable features, or any combination thereof. In a further example, feature extractor 310 may take as input any suitable deep learning features from a plurality of in-cabin sensors (e.g., a cabin monitoring camera, a steering wheel angle sensor, a microphones, any other suitable sensor, or any combination thereof).

Short Action classifier 320 is configured to determine a classification corresponding to the identified features in each frame. In some embodiments, short action classifier 320 may determine a short action for each image frame (e.g., operate at the same rate as the fps processing of feature extractor 310). For example, based on the identified features for each frame and masked versions thereof (e.g., original frame, body masked frame, face-masked frame, eye-masked frame) is classified as corresponding to one short action from among a selection of short actions. In some embodiments, for example, short action classifier 320 may take as input reference information 371 that may include links between a plurality of reference features and a plurality of short actions. For example, short action classifier 320 may be trained using training data of drivers performing known short actions, and then identify features correlated with those short actions. To illustrate, short action classifier 320 may include any suitable artificial intelligence or machine learning model that heavily leverages spatio-temporal transformers and an attention mechanism (e.g., a CNN) and may be trained on anonymized driver data. In some embodiments, the plurality of short actions may include a direction driver gaze (e.g., up, down, left right, or diagonals/combinations thereof at any suitable resolution), a state of vision (e.g., eyes open, eyes closed), head or face position (e.g., turned left, right, up, down, forward, or to the rear of the vehicle, or pitched to the side, front, or back), body position (e.g., centered in the driver's seat, off to one side, slouched), whether the driver's eyes are open or closed, the driver's body pose, a driver body bending forward, a driver body reaching to the passenger side, a driver body reaching towards a second row (e.g., a rear seat), a driver's gaze being blocked by other objects (e.g., such as sun visor or other object), any other suitable short action, or any combination thereof. In some embodiments, for example, short action classifier 320 may determine an intermediate state (e.g., looking up with eyes closed) a combination of short actions. In some embodiments, for example, short action classifier 320 may identify multiple short actions for each frame (e.g., looking up with head pitched right). In some embodiments, short action classifier 320 retrieves or otherwise accesses reference information 371 to determine, for example, threshold values, parameter values (e.g., weights), algorithms (e.g., computer-implemented instructions), offset values, or a combination thereof from memory. In some embodiments, short action classifier 320 applies an algorithm to the output of feature extractor 310 (e.g., feature values) to determine the classification. For example, short action classifier 320 may apply a least squares determination, weighted least squares determination, support-vector machine (SVM) determination, multilayer perceptron (MLP) determination, any other suitable classification technique, or any combination thereof.

In an illustrative example, system 301 or short action classifier 320 thereof may include a DMS model that is trained offline based on a large number of collected images. Features extracted from these images together with corresponding action ground truth labels (e.g., generated either manually or automatically) may allow the DMS model to learn the relationship between an image, or feature thereof, and driver actions. In some embodiments, for example, the DMS model may be configured to learn from privacy-preserved user data with minimal to no supervision (e.g., unsupervised machine learning operation).

In some embodiments, short action classifier 320 performs a short action classification for each frame capture (e.g., each image), and thus generates a classification as each new image is available. In some embodiments, short action classifier 320 performs the classification based on a set of images and accordingly may determine the classification for each frame (e.g., classify at a frequency equal to the frame rate) or a lesser frequency (e.g., classify every ten frames or other suitable frequency). In some embodiments, short action classifier 320 performs the classification at a down-sampled frequency such as a predetermined frequency (e.g., in time or number of frames) that is less than the frame rate. As an illustrative example, camera 302 may capture images at a rate of 30 frames per second, and feature extractor 310 may process images at 10 fps, and short action classifier 320 may then classify frames at 10 fps.

As illustrated, short action classifier 320 may retrieve or otherwise access settings, which may include, for example, classification settings, classification thresholds, predetermined classifications (e.g., two or more classes to which a region may belong), any other suitable settings for classifying regions of an image, or any combination thereof. Short Action classifier 320 may apply one or more settings to classify regions of an image, locations corresponding to a partition grid, or both, based on features extracted by feature extractor 310. Short action classifier 320 may be configured to select among classifications, classification schemes, classification techniques, or a combination thereof.

As illustrated, short action classifier 320 includes filter 322 that may be configured to temporally filter (e.g., smooth) output of short action classifier 320. In some embodiments, filter 322 takes as input a classification from short action classifier 320 (e.g., for each frame), and determines a smoothed classification that may, but need not, be the same as the output of short action classifier 320. In some embodiments, filter 322 may filter the sequence of identified short actions and the output a sequence of filtered short actions, at a lesser rate. For example, short action classifier may first determine a short for each frame (e.g., at 10 Hz), and then filter that sequence using filter 322 to result in a sequence of filter short actions (e.g., at a lesser rate such as 1 Hz). To illustrate, filter 322 smooths the sequence of short actions to lessen flickering or transitions between classifications, to ensure some confidence and continuity in changes of short actions. For example, filter 322 may increase latency in changes in short action classification, reduce a frequency of such changes (e.g., prevent short time-scale or frame-to-frame fluctuations), increase confidence in a transition, or a combination thereof. In some embodiments, filter 322 applies a statistical technique, a filter (e.g., a moving average or other discreet filter), any other suitable technique for smoothing short action classification, or any combination thereof. In some embodiments, filter 322 may include a learning-based machine learning model, a deterministic filter, or a combination thereof (e.g., as a single combined model) to process the short action classifications.

Long action identifier 330 is configured to take as input features from feature extractor 310, and identify long actions of the driver based on sequences of features. For example, long action identifier 330 does not necessarily identify a long action at a fixed time interval or rate, but rather identifies a long action when a sequence of features is recognized or otherwise correlated to a long action. To illustrate, as long action identifier 330 processes a feature vector from feature extractor 310, long action identifier 330 may only identify a long action if a particular pattern of features is present. Accordingly, long action identifier 330 is sequence-based rather than temporally-based, and need not output a long action at a regular frequency, or even at all (e.g., if no long action is identified). In some embodiments, long action identifier 330 takes as input a feature vector from feature extractor 310 and uses reference information 371, which may include information linking reference sequence of features and reference long actions, to identify long actions. Identifying a long actions may include, for example, determining the driver is text messaging, determining the driver is interacting with an infotainment system, determining the driver is eating, and determining the driver is sleeping. In some embodiments, system 301 may combine short action classification, long action classification, filtering, and any other suitable tasks into a single multi-task end-to-end model. In some embodiments, long actions may be built upon larger stretches of observations in time, to estimate the driver behavior (e.g., such as when they are engaged in grooming or actively controlling infotainment screens for several seconds). In some embodiments, by utilizing a relatively large context window to determine a long action distraction. For example, long action identifier 330 may use features such as a sequence of images or a sequence of low-level features extracted for each frame. To illustrate, these sequence of image, features, or both may be used to train a suitable sequential model such as Long Short Term Memory (LSTM), a Recurrent Neural Network (RNN), a Transformer architecture, any other suitable model, or any combination thereof.

Feature supervisor 340 is configured to monitor output of feature extractor 310, short action classifier 320, long action identifier 330, or a combination thereof, determine if the driver is likely distracted, and conditionally generate an output signal based on that determination. For example, if feature supervisor 340 determines that the driver is distracted, then feature supervisor 340 generates and transmits a signal to output 390. Feature supervisor 340 may provide the output signal to a notification system, and imaging system (e.g., the camera system), an auxiliary system (e.g., a touchscreen, an auditory device, a light or dash indicator), any other suitable system of output 390, or any combination thereof. In some embodiments, feature supervisor 340 provides an output signal to a notification system to generate a notification to alert the driver. For example, the notification may be displayed on a display screen such as a touchscreen of a smartphone, a screen of a vehicle console, any other suitable screen, or any combination thereof. In a further example, the notification may be provided as an LED light, console icon, or other suitable visual indicator. In a further example, a screen configured to provide a video feed from the camera feed being classified may provide a visual indicator such as a warning message, any other suitable indication overlaid on the video or otherwise presented on the screen, or any combination thereof. In some embodiments, feature supervisor 340 provides an output signal to an imaging system of a vehicle. For example, a vehicle may receive images from a plurality of cameras. If feature extractor 310 fails to detect objects or identify features for a sufficient amount of time, feature supervisor 340 may diagnose the imaging system, adjust the camera settings, adjust the image capture settings, adjust image pre-processing, provide feedback to the driver, any suitable action of camera 302, any suitable action of feature extractor 310, or any combination thereof.

Memory storage 370 may include, for example, memory hardware of the vehicle or a system thereof, in which image frames and metadata may be stored. In some embodiments, memory storage 370 may be distributed among more than one device, and may be included as part of system 301. Reference information 371 may include, for example, libraries, databases, files, any other suitable format, or any combination thereof, to store any suitable information that may be recalled and used to characterize image data captured and provided to system 301. For example, reference information 371 may include information linking a plurality of reference features and a plurality of reference short actions to generate a time sequence of short actions, information linking a plurality of reference sequences of features to a plurality of reference long actions, any other suitable information, or any combination thereof. To illustrate, reference information 371 may include hidden layer information for a CNN, including image filters of a convolution layer (e.g., corresponding to features), rectifications, weightings, pooling information, information regarding a fully connected layer, any other suitable information, or any combination thereof. Preference information 372 may include, for example, image pre-processing settings, preferred time periods (e.g., which may define distracted or not distracted), lengths of windows for filtering or analysis, any other suitable information that may adjust the operation of system 301, or any combination thereof.

Vehicle information 360 may include, for example, operating parameters or states of the vehicle. For example, vehicle information 360 may include unlocked/locked state, occupancy state, vehicle speed, vehicle on/off status, braking action, steering action, dash interactions, any other suitable information, or any combination thereof. For example, feature supervisor 340 may take as input vehicle information 360, and determine that a driver may be distracted only if the vehicle is moving, a driver is in the driver's seat, the vehicle is on, or any other suitable criteria or combination of criteria.

In an illustrative example, system 301 (e.g., feature extractor 310 thereof) may receive a set of images (e.g., repeatedly at a predetermined rate) from an output of camera 302. Feature extractor 310 may preprocess the image frames, identify objects in each frame, and then determine one or more features corresponding to the frame and masked versions thereof. Extracted features are outputted to short action classifier 320, which determines a short action for each frame based on the features extracted from the frame and masked versions thereof. Filter 322 is configured to generate a smoothed short action classification. Feature supervisor 340 takes as input the sequence of filtered short actions generated by filter 322, and determines whether the driver is distracted based on the sequence of short actions.

In a further illustrative example, system 301 may recognize two types of action-based distractions: (1) short glance change, which drivers briefly look away from road, such as checking side mirrors, briefly looking at the instrument cluster or the infotainment display, or any other suitable actions that usually take about a couple of seconds; and (2) long actions, such as text messaging, interacting with infotainment systems, eating, or other suitable actions that usually take from tens of seconds to minutes. While some conventional distraction detection methods are based on gaze estimation, and attempt to collect 3D ground truth at scale from real data, system 301 may allow the DMS to move away from a 3-D geometric gazed-based approach or multimodal sensing approach, and focus on an end-to-end approach. For example, system 301 may be configured to rely on visual inspection of driver actions during data annotation and determine whether a driver is paying attention to driving. System 301 then may apply a trained deep learning (DL) model to estimate such short and long actions directly and need not rely on gaze and geometry computation (e.g., mapping the occupant compartment to determine what the driver is looking at).

In a further illustrative example, system 301 may apply a two-stage action recognition model. In the first stage, a frame-based action classifier may be trained to learn short actions (e.g., looking left/right/up/down/on-road/closed-eyes). These frame-by-frame results may then be processed by a temporal algorithm to consolidate the results (e.g., using filter 322 to detect short actions). In the second stage, the raw output (e.g., features) from the frame-based model (e.g., the output of feature extractor 310) may be concatenated and provided to a second-stage model (e.g., a sequential model, illustrated by long action identifier 330) to estimate long actions.

In a further illustrative example, system 301 may include control circuitry configured to identify one or more objects in each frame of a plurality of image frames (e.g., using feature extractor 310), which may be captured by camera 302 (e.g., directed at an occupant compartment of the vehicle). The control circuitry may also be configured to identify one or more features for each frame based on the one or more objects (e.g., using feature extractor 310), and then determine a short action for each frame based on the one or more features and based on reference information 371 linking a plurality of reference features and a plurality of reference short actions to generate a time sequence of short actions. The control circuitry may also be configured to apply a filter, using filter 322, to the time sequence of short actions to generate a sequence of filtered short actions. Additionally, the control circuitry may be configured to cause an indication to the driver to be generated, by output 390, based on the sequence of filtered short actions. For example, the control circuitry may be configured to generate a control signal and transmit the control signal to output 390 to cause the indication.

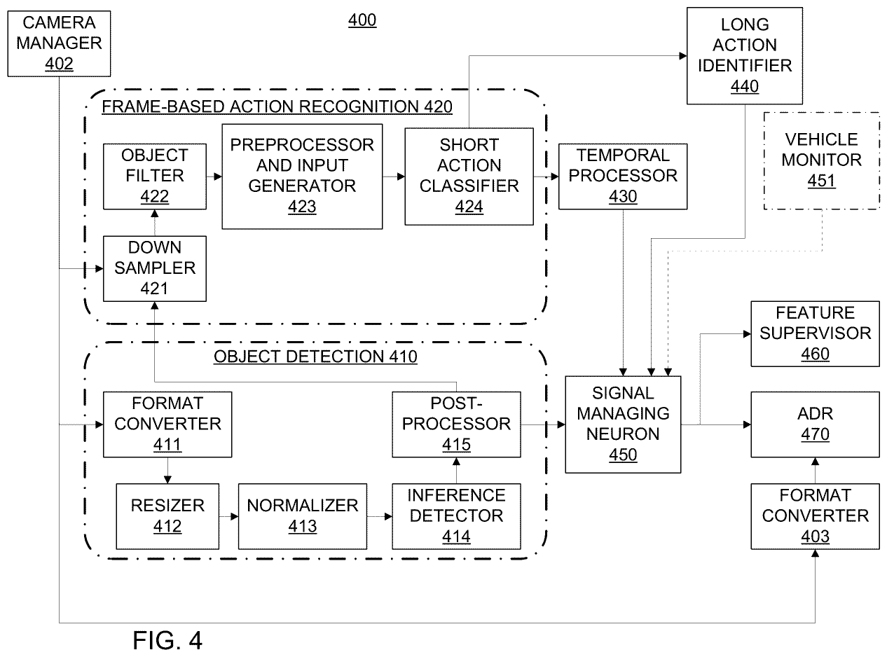

FIG. 4 is a block diagram of illustrative system 400 for managing image data, in accordance with some embodiments of the present disclosure. Camera manager 402 is configured to capture, store, and retrieve image frames from a suitable vehicle camera. For example, camera manager 402 may be configured to manage a camera operating in the visible range, infrared range, of a combination thereof. In some embodiments, the camera may capture images at a first frame rate (e.g., 30 fps).

System 400 performs object detection 410 by first receiving image frames from camera manager 402. To illustrate, object detection 410 may be performed by feature extractor 310 of FIG. 3, and may be performed at any suitable frame rate (e.g., a rate at which frame-based action recognition 420 occurs). Format converter 411 is configured to convert images from a first format to a suitable second format for object detection. In an illustrative example, format converter 411 may be configured to convert images from a native format (e.g., NV12) to a suitable format for object detection such as red-green-blue-alpha format (e.g., RGBA color designations and transparency), having any suitable number of bits. In some embodiments, resizer 412 is configured to resize image frames (e.g., to a suitable N×M pixel size). In some embodiments, normalizer 413 is configured to normalize pixel values. For example, normalizer 413 may be configured to normalize RGB values (e.g., subtract a mean value for each value and dividing by a variance or standard deviation) such that the values lie in a consistent range for the classifier. In some embodiments, inference detector 414 is configured to detect objects. For example, inference detector 414 may be configured to identify and classify objects, and determine suitable boundaries of the identified objects. In some embodiments, post-processor 415 is configured to eliminate or otherwise lessen duplicate objects and refining the boundaries of objects identified by inference detector 414. For example, post-processor 415 may be configured to apply non-maximum suppression (NMS) by identifying overlapping bounding boxes correspond to detected objects, and identify boundaries having greater corresponding confidence values. Accordingly, post-processor 415 may avoid or lessen the detection of more than one object of each type (e.g., driver body, face, eyes) per frame. In some embodiments, the output of post-processor 415 (e.g., bounding boxes or boundaries of identified objects), is provided to frame-based action recognition 420 to be used for masking, cropping, or both.

System 400 performs frame-based action recognition 420 at a suitable rate (e.g., processing 10 fps or other suitable rate less than or equal to the camera capture rate). In some embodiments, down sampler 421 is configured to down-sample the sequence of image frames from camera manager 402. For example, camera manager 402 may capture image frames a first frame rate and down sampler 421 may down-sample these frames to a second frame rate less than the first (e.g., from 30 fps to 10 fps, or any other suitable reduction). In some embodiments, object filter 422 is configured to target aspects of each frame and filter those aspects. For example, object filter 422 may be configured to filter noise, regions, brightness, shapes, or otherwise enhance aspects of the image. In some embodiments, preprocessor and input generator 423 is configured to apply masking or cropping to the image frames to generate input for a classifier. For example, preprocessor and input generator 423 may be configured to apply a body mask, a face mask, and an eye mask to the filter frame to create three masked images for classifying. Masking may include setting pixel values outside of an object boundary to a fixed value (e.g., all pixels not within a boundary of a body, face, eyes, may be set to black or a 0:0:0 RGB value). In a further example, the output of preprocessor and input generator 423 may be, for each frame, a set of masked frames corresponding to the number of masks (e.g., for three masks, three masked frames are generated). In some embodiments, the unmasked frame may also be outputted. In some embodiments, short action classifier 424 is configured to accept as input the masked frames of preprocessor and input generator 423, and determine a short action for each frame. For example, in some embodiments, short action classifier 424 may determine a confidence value for each short action classification based on the set of masked frames, and then select the greatest value as the classification. Short action classifier 424 may output a short action classification at the same rate as the frame processing rates of object detection 410 and frame-based action recognition 420 (e.g., at least one short action per frame). For example, short action classifier 424 may identify features in the masked frames, generate a feature vector, and then apply a trained CNN to the feature vector to determine short actions.

In some embodiments, temporal processor 430 is configured to temporally filter the output of short action classifier 424. For example, temporal processor 430 may apply a window filter to the sequence of short actions to determine filtered values. To illustrate, temporal processor 430 may apply a sliding window to the sequence of short actions. The sliding window may span N short actions (e.g., at N fps) and determine a most frequent short action among the N values. The most frequent short action then may be the filtered value for that sliding window position. Temporal processor 430 may prevent or otherwise lessen the occurrence of flickering among different short actions in the short action sequence. The output of temporal processor 430 may a sequence of short actions at the same rate as the output of short action classifier 424 or at a reduced rate (e.g., the window may but need not increment one frame at a time, nor overlap frames for each determination).

In some embodiments, short action classifier 424 may generate a feature vector, which long action identifier 440 may take as input. While short action classifier extracts one or more features for each frame (and corresponding masked versions) and then determines a short action for the frame based on those features, long action identifier 440 considers the feature vector for more than one frame. For example, in some embodiments, long action identifier 440 is configured to analyze a sequence of features, which may correspond to a plurality of frames, and identify long actions based on the sequence of features. For examples, some patterns or sequences of features may be linked (e.g., via reference information) to reference long actions. Long action identifier 440 may be configured to calculate confidences in a plurality of long actions based on the feature vector, and select the long action corresponding to a confidence value above a predetermined threshold. Long action identifier 440 may output a long action if identified, but need not provide output at any regular frame rate or frequency, because long action identifier 440 is sequence based rather than time-based.

In some embodiments, vehicle monitor 451 is configured to collect, format, and provide information about vehicle operation to signal managing neuron 450. For example, vehicle monitor 451 may provide signals corresponding to vehicle speed, braking activity, steering activity, locked/unlocked status, location, infotainment system usage, controls usage (e.g., turn blinkers, GPS, headlights, windshield wipers, temperature control), any other suitable vehicle information, or any combination thereof. Signal managing neuron 450 gather data and signals and formats the information for feature supervisor 460 and advanced distraction recognition (ADR) module 470. For example, signal managing neuron 450 may be configured to receive and process information from temporal processor 430, long action identifier 440, vehicle monitor 451, or any other suitable source of information. In an illustrative example, feature supervisor 460 may be configured to monitor sequences of filtered short actions (e.g., generated by temporal processor 430), features (e.g., a feature vector generated and updated by short action classifier 424), long actions (e.g., identified by long action identifier 440), and determine whether the driver is distracted. For example, feature supervisor 460 may determine a confidence value for the driver being distracted or not distracted, and if the confidence of distraction is greater thana threshold, determine that the driver is distracted. In some embodiments, feature supervisor 460 identifies periods of distraction. For example, at a suitable frequency, feature supervisor 460 may determine a distraction metric such as, distracted or not distracted (e.g., a binary classification), probability of distraction (e.g., a percentage or confidence value), a length or duration of distraction (e.g., a time or number of cycles where the driver is continuously distracted), a class of distraction, any other suitable metric, or any combination thereof. Based on the metric, or a sequence of metrics, feature supervisor may determine the driver is distracted. For example, if feature supervisor 460 determines the driver is distracted during a time period (e.g., four seconds or any other suitable time), feature supervisor 460 may cause an indication to be generated to the driver to alert the driver that distraction was detected (e.g., and to stay alert). In some embodiments, feature supervisor 460, ADR 470, or both may be configured to transmit a signal to an output interface (e.g., output 390 of system 300) based on at least one operating parameter of the vehicle, one or more short actions, or one or more long actions.

FIG. 5 is a flowchart of illustrative process 500 for determining short actions of a driver, in accordance with some embodiments of the present disclosure. To illustrate, process 500 may be implemented by DMS 150 of FIG. 1, system 300 of FIG. 3, or system 400 of FIG. 4, or suitable subsystems thereof.

Step 502 includes capturing image frames using a vehicle camera. In some embodiments, image frames may be captured at a fixed frame rate, corresponding to a frame rate of a vehicle camera. In some embodiments, step 502 may be performed when a driver is detected (e.g., based on motion or a seat sensor), an unlocked/locked state of the vehicle (e.g., a keyfob detected), upon startup of the vehicle, upon motion of the vehicle, at any other suitable time, or any combination thereof. In some embodiments, more than one camera may be configured to capture images, and accordingly process 500 may be applied to capture more than one stream of image frames.

Step 504 includes detecting one or more objects in each frame. In some embodiments, objects may include the driver, the driver's body, the driver's face, the diver's eyes, any other suitable object (e.g., phone, glasses, hat, container, sun-visor), or a combination thereof. In embodiments, for example, step 504 includes determining a boundary (e.g., a bounding box) corresponding to each object. In some embodiments, step 504 may include applying non-maximum suppression to prevent duplicate objects, select the most probable boundary (e.g., having the greatest confidence value), or otherwise improve object detection. The output of step 504, for example, may be the bounding boxes for each object detected in the frame. Either or both of steps 502 and 504 may include any suitable pre-processing of the image frames (e.g., format conversion, normalizing, filtering, resizing, or any other suitable processing).

Step 506 includes applying one or more object masks to each frame. In some embodiments, based on each bounding box from step 504 for a frame, the system generates a masked or cropped frame. A masked frame may include the portion of the full image frame within the bounding box, with all pixels outside of the bounding box set to a reference value (e.g., to black). Accordingly, when filters or other operations are applied to masked images, only the pixels in the bounding box will result in a non-trivial output. For a given frame, step 506 may include generating M masked frames. For example, step 506 may output a set of masked frames, where the set includes just the M masked frames, or the M masked frames along with the full frame (a set of M+1). In some embodiments, step 506 may include cropping the frame to generate a set of cropped frames, removing pixels that are outside of each respective bounding box. For example, a body, face, and eye crop may be generated by applying three bounding boxes to the full frame, and selecting only pixels within each respective bounding box as the respective cropped image.

In an illustrative example, steps 504 and 506 may include determining whether objects are detected, and which masks may be generated. For example, in some embodiments, one or more boundary boxes might not be determinable based on object detection, as shown in Table 1:

TABLE 1
Illustrative circumstances without detections.

| | No body | No Face | No Left Eye | No Right |
|---|---|---|---|---|
| | bbox | bbox | bbox | Eye bbox |
| Full Frame | always yes? | | | |
| Body Crop | zeros | — | — | — |
| Face Crop | | zeros | — | — |
| Eye Crop - left | | | zeros | — |
| Eye Crop - right | | | | zeros |

For example, in a circumstance where no body bounding box (bbox) is identified, but a face bounding box is identified, the system may use a full black image (e.g., no pixels in a bounding box), a face crop, and an eye crop, if available. In a further example, if no face crop is available, the system may use a body crop, a full black image, and an eye crop, if available. In a further example, where masks are applied rather than cropping, masked frames may be treated similarly (e.g., a full black mask may be applied if a respective object is not detected). In a further example, the system may skip frames for which no objects are detected.

Step 508 includes identifying one or more features in each frame. In some embodiments, step 508 includes identifying one or more features in the pre-processed full frame, and for each masked or cropped frame corresponding to that full frame. Accordingly, for each frame processed, step 508 may include identifying features based on the frame and masked versions of the frame and based on those features, determine a short action for the frame at step 510. In some embodiments, step 508 includes implementing a CNN, for example, having one or more hidden layers configured to determine correlation values with features. For example, the hidden layers may include filters that correspond to features such as points, edges, shapes, textures, patterns, gradients, maximums, minimums, any other suitable aspect of an image, or any combination thereof. Step 507 includes retrieving reference information. For example, step 507 may include retrieving reference information regarding the CNN (e.g., hidden layer information), and any other suitable information. In some embodiments, for each frame, step 508 includes determining one or more features based on the frame and/ow masked or cropped versions of the frame (e.g., generated at step 506).

Step 510 includes determining one or more short actions for each frame. To illustrate, for each image frame, there may be a plurality of corresponding features that are identified at step 508, and step 510 may include considering that plurality of features to determine a short action corresponding to the image frame. In an illustrative example, at a frame rate of 10 fps, step 510 may output a short action at a rate of 10 Hz. For example, determining the short action may include determining the driver is looking to a side, determining the driver is looking upward, determining the driver is looking downward, determining the driver is looking at the road, or determining the driver's eyes are closed.

Step 512 includes filtering the one or more short actions in time. In some embodiments, step 512 includes applying a sliding window to the sequence of short actions determined at 510, to generate a sequence of filtered short actions. The filter may take as input the last N short actions, corresponding to the last N frames, and determine a most frequent short action, a composite short action, or otherwise a representative short action. The filter may allow for a reduction in flickering in the sequence of short actions provided to a feature supervisor.

In an illustrative example, panel 550 illustrates some aspects of process 500. As illustrated, frame FR0 is captured at step 502, and object detection 554 occurs at step 504. Once detected, and bounding boxes are generated, cropping/masking 556 occurs at step 506, based on the bounding boxes. As illustrated, three masks are applied to frame FR0, resulting in three masked images. The masked images are provided to CNN backbone 558 to identify features at step 508. The identified features are then taken as input by classifier 560 at step 510, which determines a short action for frame FR0 based on the identified features. The output of classifier 560 may be filtered and provided to a feature supervisor, which may be configured to determine whether the driver is distracted based on the sequence of short actions, or filtered short actions over any suitable period of time (e.g., a few seconds such as four seconds, five seconds, or any other suitable period).

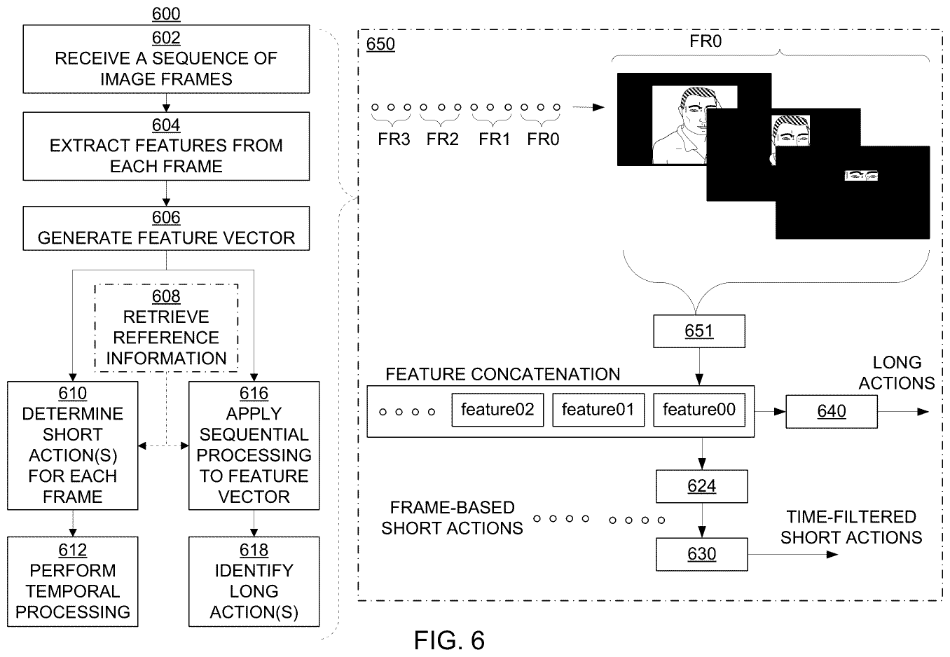

FIG. 6 is a flowchart of illustrative process 600 for determining short actions and long actions of a driver, in accordance with some embodiments of the present disclosure. To illustrate, process 600 may be implemented by DMS 150 of FIG. 1, system 300 of FIG. 3, or system 400 of FIG. 4, or suitable subsystems thereof.

Step 602 includes receiving a sequence of image frames. In some embodiments, image frames may be received at a fixed frame rate, corresponding to a frame rate of a vehicle camera. In some embodiments, step 602 may be performed when a driver is detected (e.g., based on motion or a seat sensor), an unlocked/locked state of the vehicle (e.g., a keyfob detected), upon startup of the vehicle, upon motion of the vehicle, at any other suitable time, or any combination thereof.

Step 604 includes extracting features from each frame received at step 602. In some embodiments, step 604 includes masking the frame to generate a set of masked images based on the frame (e.g., which may include the full frame itself). For example, the set may include the frame, a body-masked frame, a face-masked frame, and an eye-masked frame. In some embodiments, a neural network (e.g., a convolution neural network) may take the set as an input layer, apply one or more convolution layers to the input layer, and identify features. The CNN also may determine a classification (e.g., a most probable classification or classification having a sufficient confidence value)

Step 606 includes generating a feature vector based on the extracted features. For example, the one or more features associated with each frame are concatenated into a vector. Step 606 may include appending the feature vector with new features as frames are processed and features are identified (e.g., at the frame processing rate of a feature extractor).

Step 608 includes optionally retrieving reference information. In some embodiments, step 608 includes retrieving weighting information, hidden layer information, or any other suitable information that may be used to classify short actions, identify long actions, or both. In some embodiments, step 608 includes reference information linking a plurality of reference features and a plurality of reference short actions, reference information linking a plurality of reference sequences of features to a plurality of reference long actions, any other suitable reference information, or any combination thereof.

Step 610 includes determining one or more short actions, and step 612 includes performing temporal processing of the one or more short actions. For example, for each frame, step 610 may include determine a short action classification based on the features associated with that frame. Step 612 may include temporally filtering the short actions to help lessen flickering and smooth the result. For example, step 612 may include applying a filter by applying a window to a respective subset of short actions of the time sequence of short actions, and then determining a respective time-filtered short action based on the respective subset of short actions.

Step 616 includes applying sequential processing to the feature vector, and step 618 includes identifying one or more long actions. Step 616 may include analyzing a larger number of features than step 610, for example, because sequential processing may consider a larger window of the feature vector corresponding to a plurality of frames. In some embodiments, step 616 includes applying a sliding window to the feature vector (e.g., a window in time duration or number of frames), and analyzing the sequence of features in the windowed feature vector. Accordingly, step 616 may be performed at any suitable rate, equal to or less than the rate frames are processed, although identifying a long action may occur at a lesser frequency (e.g., long actions need not be identified for each window). For example, the window may include a minute, or any other suitable time period, of the feature vector. The system may identify long actions at step 618, by determining correlation values with reference sequences and reference long actions (e.g., of reference information retrieved at step 608).

In an illustrative example, panel 650 illustrates some aspects of process 600. As illustrated, frames FR0, FR1, FR2, and FR3 (from recent to oldest) received at step 602, are masked or cropped at step 604. As illustrated, three masks are applied to each frame, resulting in three masked images. The masked images are provided to processor 651 (e.g., a CNN backbone), with extracts features from the three masked images and concatenates them, illustrated by feature00, feature01, and feature02 (e.g., elements of a feature vector). The features are then provided short action classifier 624, which determines a short action for frame FR0 based on feature00, feature01, and feature02. Temporal processor 630 filters the sequence of short actions from short action classifier 624, corresponding to the sequence of image frames, to determine a filtered sequence of short actions (also referred to as time-filtered short actions). Sequential model 640 (e.g., similar to long action identifier 440 of FIG. 4) receives the feature concatenation (e.g., a feature vector), corresponding to a plurality of frames (e.g., frames FR0, FR1, FR2, FR3 and previous frames). For example, sequential model 640 may receive features for N frames, or may otherwise apply a sliding window to the feature vector that corresponds to N frames. In a further example, sequential model 640 may receive features for T seconds, or may otherwise apply a sliding window to the feature vector that corresponds to the last T seconds. In a further example, sequential model 640 may receive features for F features, or may otherwise apply a sliding window to the feature vector that corresponds to the last F features identified (e.g., corresponding to a plurality of frames).

In a further illustrative example, the system may implement process 600 and determine short actions that correspond to the driver's eyes being on the road at step consistently at step 612 and also a long action that the driver is on a phone call at step 618. A feature supervisor (e.g., feature supervisor 460 of FIG. 4) may, based on these determinations, determine that the driver is not distracted even though a long action is identified. Accordingly, the feature supervisor may consider both short and long actions in determining whether the driver is distracted.

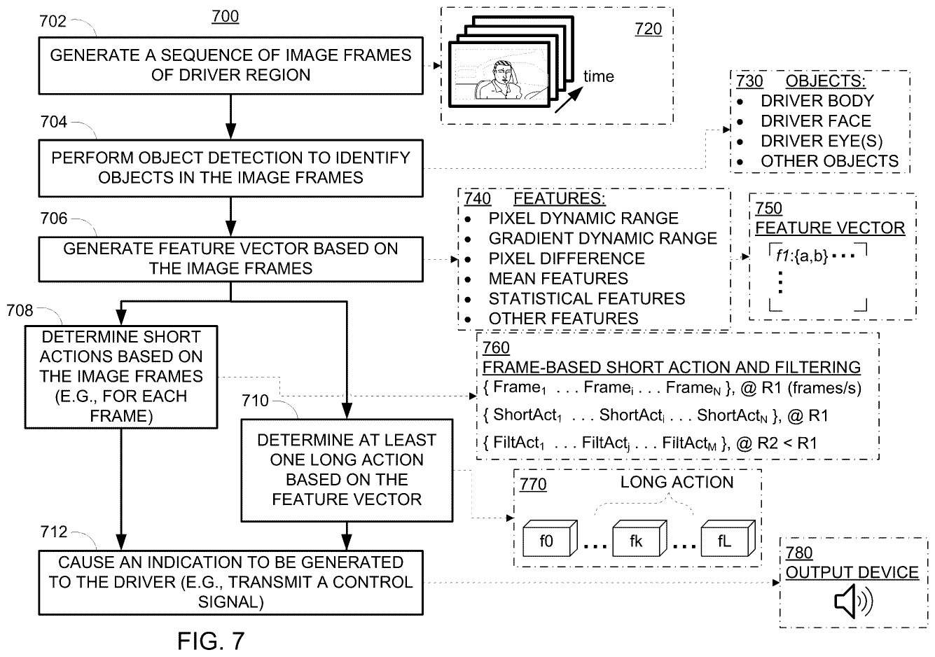

FIG. 7 is a flowchart of illustrative process 700 for monitoring a driver of a vehicle, in accordance with some embodiments of the present disclosure. To illustrate, process 700 may be implemented by DMS 150 of FIG. 1, system 300 of FIG. 3, or system 400 of FIG. 4, or one or more suitable subsystems thereof.

Step 702 includes generating a sequence of image frames of a driver region. In some embodiments, one or more vehicle cameras are directed at the driver's seat region of the occupant compartment. The one or more cameras may each be configured to capture images, which may be stored in any suitable memory storage of the vehicle. For example, the vehicle may include memory storage as part of a central processing unit or control unit, as part of a DMS of the vehicle, as part of a vehicle management system, or as part of any other suitable system. In some embodiments, the image frames are processed and stored in blocks of a predetermined number of images, which may be retrieved by the system when performing process 700.

Step 704 includes performing object detection to identify objects in the image frames. In some embodiments, step 704 may be the same step 504 of process 500 of FIG. 5. For example, in some embodiments, objects may include the driver, the driver's body, the driver's face, the diver's eyes, any other suitable object, or a combination thereof. Step 704 includes determining a boundary (e.g., a bounding box) corresponding to each object. To illustrate, step 704 may include identifying one or more objects in each frame by performing at least one of applying a body mask to each frame to identify pixels corresponding to a body of the driver, applying a face mask to each frame to identify pixels corresponding to a face of the driver, and applying at least one eye mask to each frame to identify pixels corresponding to at least one eye of the driver.

Step 706 includes generating a feature vector based on the image frames. As one or more features are identified for each frame, the features are concatenated with features identified from previous frames to append a feature vector. In some circumstances, step 706 need not be performed, or may otherwise include appending the feature vector with a null feature when no objects are identified in a frame or otherwise no features are detected. The feature vector may include any suitable dimensionality, and may include features for a plurality of frames, arranged in any suitable order (e.g., chronological order according to frame). To illustrate, step 706 may include identifying one or more features by extracting one or more features from each frame (e.g., and masked or cropped version thereof) of a sequence of image frames to generate a feature vector.

Step 708 includes determining short actions based on the image frames. Step 708 may be the same as or similar to step 510 of process 500 or step 610 of process 600. Step 708 may include classifying each frame as corresponding to a short action based on reference information. To Illustrate, step 706 may include generating a feature vector that includes the identified one or more features for each frame of the plurality of image frames, and step 708 may include determining the short action for each frame based in part on at least a portion of the feature vector.

Step 710 includes determining at least one long action based on the feature vector. Step 710 may be the same as or similar to step 618 of process 600, for example. Determining the at least one long action may be based on a sequence of features of the feature vector. Step 710 may include, for example, windowing the feature vector and analyzing sequences of features in the window. In some embodiments, control circuitry of the system is further configured to determine at least one long action based on the feature vector at step 710, and then cause the indication to be generated is based on the at least one long action at step 712. For example, determining the at least one long action may include determining the driver is text messaging, determining the driver is interacting with an infotainment system, determining the driver is eating, or determining the driver is sleeping. In a further example, step 710 may include determining the at least one long action based on the sequence of short actions of step 708, where the at least one long action corresponds to a plurality of image frames spanning more than one second.

Step 712 includes causing an indication to be generated to the driver. Based on the sequence of shorts and any determined long actions at steps 708 and 710, a feature supervisor may determine that the driver is distracted and cause an indication to the driver to be generated by a suitable output device. In some embodiments, the vehicle includes an output interface configured to generate the indication, and the control circuitry is configured to transmit a signal to the output interface at step 712 to cause the indication to be generated.

For example, process 700 may correspond to a technique for monitoring activity of a driver in a vehicle. Step 704 may include identifying, using control circuitry, one or more objects in each frame of a plurality of image frames. For example, the plurality of image frames may be captured by a camera directed at an occupant compartment of the vehicle. Step 706 may include identifying, using the control circuitry, one or more features for each frame based on the one or more objects detected at step 704. Step 708 may include determining, using the control circuitry, a short action for each frame based on the one or more features and based on reference information to generate a time sequence of short actions. Step 708 may also include applying a filter to the time sequence of short actions to generate a sequence of filtered short actions. Step 712 may include transmitting a signal to an output interface to generate an indication to the driver based on the sequence of filtered short actions.

In a further example, process 700 may correspond to a technique for monitoring activity of a driver in a vehicle based on both short and long actions. Step 706 may include extracting, using control circuitry, one or more features from each frame of a sequence of image frames to generate a feature vector. Step 708 may include determining, using the control circuitry, a sequence of short actions based on the feature vector and based on first reference information linking a plurality of reference features and a plurality of reference short actions. Step 710 may include determining, using the control circuitry, at least one long action based on the feature vector and based on second reference information linking a plurality of reference features and a plurality of reference long actions. Step 712 may include transmitting a signal to an output interface to generate an indication to the driver based on the sequence of short actions and based on the at least one long action.

In an illustrative example, panel 720 illustrates a plurality of image frames, captured sequentially in time at a suitable rate of frames per second. For example, the plurality of image frames may be stored at step 702 in memory storage 370 or any other suitable memory. In an illustrative example, panel 730 illustrates objects that may be detected at step 704 (e.g., by feature extractor 310 of FIG. 3) such as a driver body, driver face, driver eyes, or any other suitable objects. In another illustrative example, panel 740 illustrates exemplary features (e.g., that feature extractor 310 may identify). In a further example, as illustrated in panel 750, a feature vector may be generated at step 706 by concatenating the detected features “f” for each frame (e.g., for a frame Frame1, features f1 may include one or more features). Panel 760 illustrates a determination of frame-based short actions at step 708. For example, for a sequence of frames Frame₁-Frame_{N} (e.g., where “i” is an index), a sequence of short actions SHortAct₁-ShortAct_{N} (e.g., where “i” is an index) may include [L L R U L L U U L U U U], and when may be filtered using a 5-frame window to generate filtered sequence [L L L/U U L U U U], or a 10-frame window to generate [L U U] (e.g., the lengths of the filtered values FiltAct₁-FiltAct_{M} (e.g., where “j” is an index), where M may but need not equal N) differing based on the limited data set). The frame rate R1 may correspond to the rate at which frames are processed, and at which short actions are determined. The rate R2 of the filtered short actions may be same as or less than R1. Panel 770 illustrates a window of the feature vector, including features f₀-f_{L} corresponding to a total of L features (e.g., where “k” is an index) for F frames (e.g., a plurality of frames). Panel 780 illustrates an auditory indication being generated (e.g., by a suitable device such as device 203 of FIG. 2) to the driver at step 712 if it is determined that the driver is distracted.

In a further illustrative example, control circuitry may be configured to determine the at least one long action at step 710 based on the sequence of short actions determined at step 708, and any other suitable information (e.g., the feature vector). For example, the identified at least one long action may corresponds to a plurality of image frames spanning more than one second (e.g., each frame corresponding to a short action). In some embodiments, step 708 may include determining a short action for each frame independent of geometric mapping of the occupant compartment, and step 710 may include determining the at least one long action independent of geometric mapping of the occupant compartment.

It will be understood that any of the systems, devices, or components illustrated in FIGS. 1-4 may be combined, omitted, rearranged, or otherwise modified in accordance with the present disclosure. It will also be understood that processes 500, 600, and 700 of FIGS. 5-7, or any suitable steps thereof, may be combined, omitted, rearranged, or otherwise modified in accordance with the present disclosure.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A method for monitoring activity of a driver in a vehicle, comprising:
identifying, using control circuitry, one or more objects in each image frame of a plurality of image frames, wherein the plurality of image frames is captured by a camera directed at an occupant compartment of the vehicle;
identifying, using the control circuitry, one or more features for each image frame based on the one or more objects;
determining, using the control circuitry, a short action for each image frame based on the one or more features and based on reference information linking a plurality of reference features and a plurality of reference short actions to generate a time sequence of short actions;
applying a filter to the time sequence of short actions to generate a sequence of filtered short actions; and
transmitting a signal to an output interface to generate an indication to the driver based on the sequence of filtered short actions.

2. The method of claim 1, wherein determining the short action comprises at least one of:
determining the driver is looking to a side;
determining the driver is looking upward;
determining the driver is looking downward;
determining the driver is looking at a road; and
determining the driver's eyes are closed.

3. The method of claim 1, wherein identifying the one or more objects comprises at least one of, for each image frame:
identifying first pixels corresponding to a body of the driver;
identifying second pixels corresponding to a face of the driver; and
identifying third pixels corresponding to at least one eye of the driver.

4. The method of claim 1, wherein applying the filter comprises:
applying a window to a respective subset of short actions of the time sequence of short actions; and
determining the respective filtered short action based on the respective subset of short actions.

5. The method of claim 1, further comprising generating a feature vector comprising the identified one or more features for each image frame of the plurality of image frames, wherein determining the short action for each image frame is based in part on the feature vector.

6. The method of claim 5, wherein the reference information is first reference information, further comprising determining at least one long action based on the feature vector and based on second reference information linking a plurality of reference sequences of features to a plurality of reference long actions.

7. The method of claim 5, further comprising determining at least one long action based on the feature vector, wherein transmitting the signal to the output interface to generate the indication is further based on the at least one long action.

8. The method of claim 7, wherein determining the at least one long action comprises at least one of:
determining the driver is text messaging;
determining the driver is interacting with an infotainment system;
determining the driver is eating; and
determining the driver is sleeping.

9. The method of claim 7, wherein:
determining the short action for each image frame is independent of geometric mapping of the occupant compartment; and
determining the at least one long action is independent of geometric mapping of the occupant compartment.

10. A method for monitoring activity of a driver in a vehicle, comprising:
extracting, using control circuitry, one or more features from each image frame of a sequence of image frames to generate a feature vector;
determining, using the control circuitry, a sequence of short actions based on the feature vector and based on first reference information linking a first plurality of reference features and a plurality of reference short actions;
determining, using the control circuitry, at least one long action based on the feature vector and based on second reference information linking a second plurality of reference features and a plurality of reference long actions; and
transmitting a signal to an output interface to generate an indication to the driver based on the sequence of short actions and based on the at least one long action.

11. The method of claim 10, wherein transmitting the signal to the output interface is further based on at least one operating parameter of the vehicle.

12. The method of claim 10, further comprising applying a time filter to the sequence of short actions to generate a sequence of filtered short actions, wherein:
determining the sequence of short actions occurs at a first rate;
the time filter comprises a window spanning more than one image frame; and
the sequence of filtered short actions corresponds to a second rate less than or equal to the first rate.

13. The method of claim 10, wherein determining the at least one long action is based on a sequence of features of the feature vector.

14. The method of claim 10, wherein:
determining the at least one long action is further based on the sequence of short actions; and
the at least one long action corresponds to a plurality of image frames spanning more than one second.

15. A system comprising:
control circuitry configured to:
identify one or more objects in each image frame of a plurality of image frames, wherein the plurality of image frames is captured by a camera directed at an occupant compartment of a vehicle;
identify one or more features for each image frame based on the one or more objects;
determine a short action for each image frame based on the one or more features and based on reference information linking a plurality of reference features and a plurality of reference short actions to generate a time sequence of short actions;
apply a filter to the time sequence of short actions to generate a sequence of filtered short actions; and
cause an indication to a driver to be generated based on the sequence of filtered short actions.

16. The system of claim 15, further comprising an output interface configured to generate the indication, wherein the control circuitry is configured to transmit a signal to the output interface.

17. The system of claim 15, wherein identifying the one or more features comprises extracting one or more features from each image frame of the plurality of image frames to generate a feature vector.

18. The system of claim 17, wherein the control circuitry is further configured to:
determine at least one long action based on the feature vector; and
cause the indication to be generated is based on the at least one long action.

19. The system of claim 18, wherein:
the control circuitry is configured to determine the at least one long action further based on the time sequence of short actions; and
the at least one long action corresponds to a set of image frames spanning more than one second.

20. The system of claim 18, wherein the control circuitry is configured to:
determine the short action for each image frame independent of geometric mapping of the occupant compartment; and
determine the at least one long action independent of geometric mapping of the occupant compartment.
